(19) United States
(12) Patent Application Publication
(10) Pub. No.: US 2002/0190719 A1
(43) Pub. Date: Dec. 19, 2002

(54) System and method for making an ignition coil

(76) Inventor: Robert C. Souder, Indianapolis, IN (US)

Correspondence Address: MARGARET A. DOBROWITSKY, DELPHI TECHNOLOGIES, INC., Legal Staff, P.O. Box 5052, Mail Code: 480-414-420, Troy, MI, 48007-5052, US

(21) Appl. No.: 09/878,494

(22) Filed: Jun. 11, 2001

(51) Int. Cl. F02P 17/00

(52) U.S. Cl. 324/388

(57) ABSTRACT

An improved system and method for adjusting an air gap in a core portion of an ignition coil includes a low-cost circuit for providing real-time determination of an inductance of one of the windings of the ignition coil being assembled. The circuit includes an AC power source in series relationship with a resistive element and the ignition coil. The circuit further includes a controller, such as a programmable logic controller (PLC) to read voltages across the resistor and ignition coil and calculate an inductance, using data determined in a calibration step. A machine is controlled to adjust the air gap until the calculated inductance equals a desired inductance. Reduced cost, and improved immunity to TIG welder noise is provided.

### BACKGROUND OF THE INVENTION

1. Technical Field

This invention relates generally to a method of making an ignition coil, and, more particularly, to a system and method for adjusting a core portion of the ignition coil of the type used in a spark ignition system of an internal combustion engine.

2. Description of the Related Art

It is known to make a laminated core for an ignition coil wherein the core has a generally E-shaped (or W-shaped) part and an I-shaped (or bar-shaped) part, as seen by reference to U.S. Pat. No. 4,480,377 issued to House et al. House et al. further disclose that the E-shaped part has a foreshortened center leg relative to its outer legs so that an air gap may be formed between an end surface of the center leg and a lower surface of the bar-shaped core part. A primary coil and a secondary coil are wound on the core. A process of assembly is disclosed wherein current is applied to one of the coils and the resulting inductance is measured. Since the inductance varies with variance of the air gap, such gap can be adjusted until the measured inductance reaches a desired value. When the desired air gap is obtained (as shown by the measured inductance), the core parts are welded together.

In a conventional configuration, an RLC (resistance, inductance, capacitance) meter is used to monitor the inductance during the assembly process, or, alternatively, a complicated custom circuit board is used. However, the custom circuit board and the RLC meter approach are both relatively expensive approaches, thus increasing the cost of manufacturing the ignition coils. Moreover, it has been observed that conventional RLC meters have a relatively high sensitivity to noise due to the presence of tungsten inert gas (TIG) welding machines commonly used to weld the core parts together. This leads erroneous meter output and/or meter failure in some instances.

There is therefore a need for an improved method of making an ignition coil that minimizes or eliminates one or more of the problems set forth above.

### SUMMARY OF THE INVENTION

One advantage of the present invention is to provide a solution to one or more of the problems as set forth in the Background. One advantage of the present invention is that is provides a substantially reduced cost solution to the problem of determining, in real-time, an inductance of an ignition coil so that an air gap may be adjusted to a predetermined, desired value. Another advantage of the present invention is that it is superior in noise tolerance to conventional systems, for example, those employing an RLC meter, due to the meter's high sensitivity to the presence of TIG welders.

A method of making an ignition coil includes the basic steps of (i) calibration, (ii) determining an inductance value, and (iii) adjusting an air gap. The first step involves calibrating a test circuit using a predetermined inductance to thereby determine an actual resistance value of the test circuit. In a preferred embodiment, for example, the predetermined inductance may comprise a master coil. The next step involves determining the inductance value associated with the ignition coil being made, using the previously determined actual resistance value of the test circuit. Finally, the last basic step involves adjusting the air gap in the coil so that the determined inductance value equals a desired inductance value.

An apparatus for determining an inductance value of an ignition coil so as to enable air gap adjustment is also presented.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is a side view, with portions broken away and sectioned, showing an ignition coil manufactured in accordance with the present invention;

FIG. 2 is a simplified schematic and block diagram view of a test circuit for use in making the ignition coil illustrated in FIG. 1; and

FIG. 3 is a flowchart diagram illustrating the steps of a method according to the invention.

### DETAILED DESCRIPTION OF THE PREFERRED EMBODIMENTS

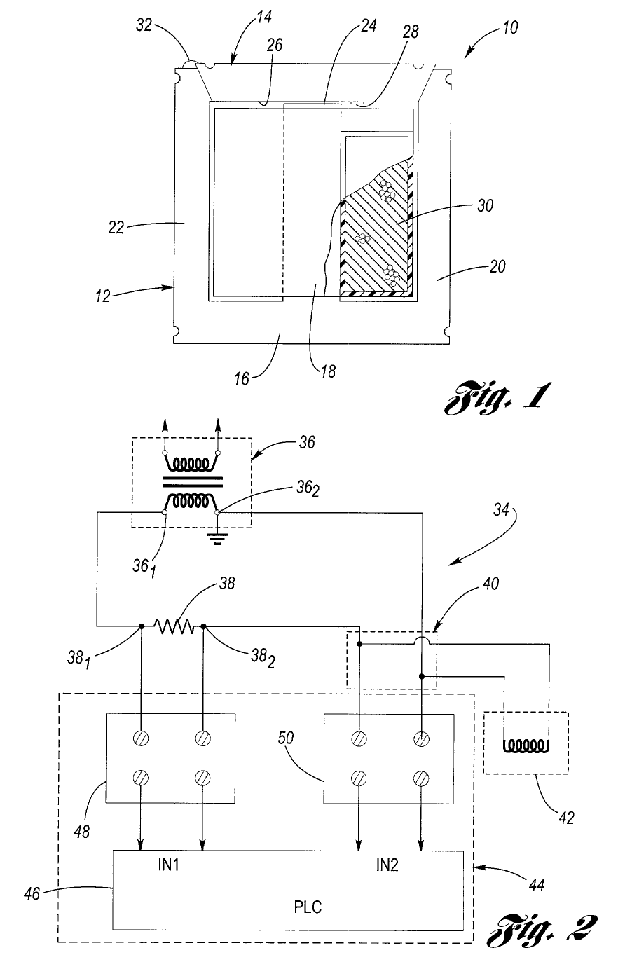

Referring now to the drawings wherein like reference numerals are used to identify identical components in the various views, FIG. 1 is a partially cut-away side view of an ignition coil 10 having a core manufactured in accordance with the present invention. FIG. 1 is but exemplary of one configuration of ignition coil that may be manufactured in accordance with the present invention. It should be understood that other configurations are possible and yet remain within the spirit and scope of the invention. Coil 10, as illustrated, includes a magnetically-permeable core comprising first and second members 12 and 14. Core member 12 as illustrated has a generally W-shaped (or E-shaped) arrangement of features including a base 16, a central leg 18 projecting generally perpendicularly relative to base 16, a pair of outer legs 20 and 22 extending from the opposite ends of base 16 in the same direction as center leg 18 and generally parallel thereto. Center leg 18 includes a flat end surface 24, and is shorter than the substantially equal length outer legs 20 and 22. Flat end surface 24 is substantially perpendicular to an axis (not shown) of center leg 18.

Core member 14, as illustrated, is generally I-shaped (or bar-shaped) and includes a surface 26 that faces flat end surface 24 in an assembled state. As shown, core member 14 is substantially perpendicular to central leg 18.

In the illustrated embodiment, core members 12 and 14 are made, for example, of a plurality of laminated layers of relatively thin grain oriented, electrical steel, as understood by those of ordinary skill in the art. Other magnetically permeable materials known to those of ordinary skill in the art are likewise suitable for use in the present invention.

An air gap 28 is defined between flat end surface 24 and lower surface 26 of the I-shaped core member 14.

Ignition coil 10 further includes suitably configured windings that define a transformer 30 for transforming a relatively low voltage, such as 12 volts that may be commonly found in an automotive vehicle, to a voltage sufficient to initiate a spark when coupled to a spark plug. The transformer 30 is shown only in representative form, being wound on an insulated spool or the like. As known, transformer 30 may comprise a pair of coil windings, a primary coil coupled to the lower input voltage (e.g., 12v) with a relatively small number of turns, and a secondary coil having a much greater number of turns, having a high voltage end configured to be coupled to a spark plug, all as well known in the art of ignition coils.

During assembly, I-shaped core member 14 is moveable relative to W-shaped member 12 so as to vary the air gap 28. This adjustment process will be described in greater detail below. Once the desired air gap has been obtained, the first and second core members 12 and 14 are secured, one to the other, such as by way of, for example, welding. In one embodiment, tungsten inert gas (TIG) welding is used. As shown in diagrammatic fashion in FIG. 1, the welding operation results in one or more welding beads 32 (only one shown for clarity).

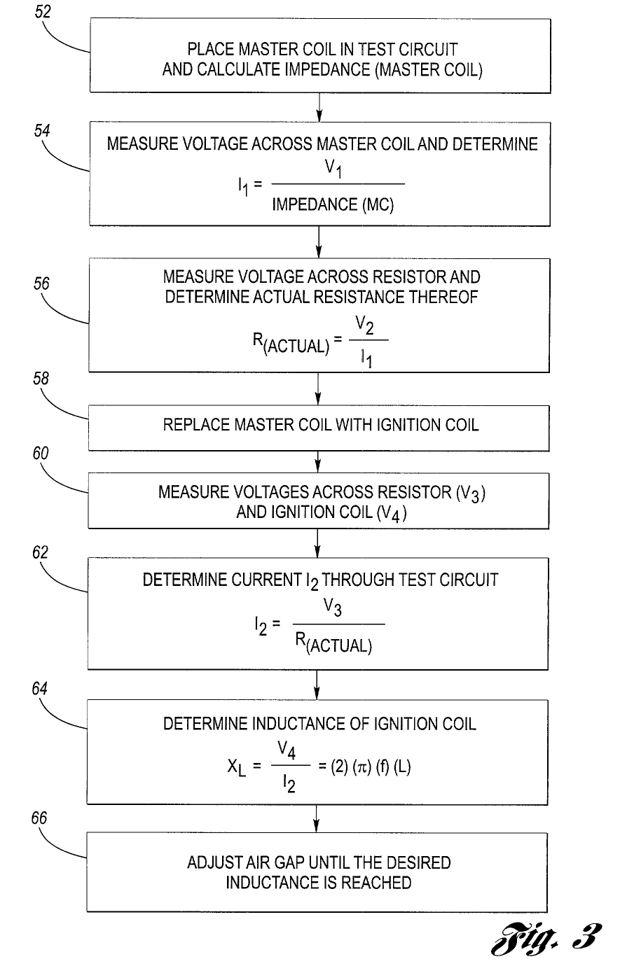

FIG. 2 shows a test circuit 34 used in the process of adjusting the air gap of ignition coil 10. The inductance of one of the windings of ignition coil 10 depends in large part on the air gap 28. It is desirable to have substantially the same inductance on an ignition coil-to-ignition coil basis during manufacture and to have a low variation relative to a predetermined nominal inductance. A portion of the assembly process of the ignition coil 10 includes the steps of measuring the inductance of one of the windings of transformer 30 of ignition coil 10 and adjusting the position of core member 14 relative to core member 12 (and thus also the air gap) until a desired inductance is obtained. Then, the core members 12 and 14 are joined or otherwise secured one to another in order to maintain the adjusted air gap thereafter. Conventionally, the inductance of one of the windings of transformer 30 is determined by connecting the winding to an RLC meter, or via the application of current to one of the windings via custom circuit boards or the like, as described in the Background. Circuit 34 represents an improvement over the conventional art both in its simplicity and reduced cost, as well as its tolerance to noise in the presence of TIG welding machines and the like. The basic methodology of making an ignition coil according to the invention includes the step of calibrating test circuit 34 using a predetermined inductance, such as a master coil to thereby determine an actual resistance value of the test circuit. Then, replacing the master coil with the ignition coil to be assembled, and determining an inductance value associated with one of the windings of transformer 30 (e.g., the primary winding), using the previously determined actual resistance value. Finally, adjusting the air gap of the ignition coil being assembled so that the inductance being determined in real time by circuit 34 equals a desired inductance value.

Circuit 34 includes an alternating current (AC) power source 36 having first and second output terminals 36_{1 and 36}₂, a resistive element 38 having first and second ends 38₁ and 38₂, a structure 40 configured to receive one of a master coil 42 having a known inductance or an ignition coil to be adjusted and assembled, and a controller 44.

AC power source 36 may comprise a standard AC transformer operating from, for example, a 120 volt AC, conventional power line input at 60 Hz, and developing a reduced voltage AC output (e.g., 12.6 volts) at a like frequency. Transformer 36 may comprise conventional components well known to those of ordinary skill in the art.

Resistive element 38 is connected in series with power source 36, with the output terminal 36₁ being coupled to resistor end 38₁. In a constructed embodiment, resistive element 38 may comprise a resistor having a resistance up to 50 Ω, and which may be a 4 Ω, 1% resistor in a constructed embodiment. The value corresponds suitably to the impedance of an 8 mH primary coil of transformer 30, whose impedance is about 3 Ωat 60 Hz. This ensures a suitable amount of voltage change when the air gap is adjusted. Variations of the resistance, of course, are possible and yet remain within the spirit and scope of the present invention. If the resistance is too low, however, a voltage drop thereacross begins to be less and less significant, having due regard for the other resistances in test circuit (e.g., wires, etc.).

Structure 40 is provided at the second output terminal 36₂ of AC power source 36, and the second end 38₂ of resistive element 38. Structure 40 is configured to receive either the master coil 42, as shown in FIG. 2, or an ignition coil 10, particularly one of the windings contained in transformer 30 thereof. Structure 40 may be terminal ends or the like designed for ease in connecting and disconnecting wire ends.

Controller 44 is configured to receive input signals from the circuit 34, perform calculations, and to output, in real-time, an inductance value of an ignition coil being assembled, the winding of which being connected to structure 40. As shown in FIG. 2, controller 44 may include a programmable logic controller (PLC) 46 having a pair of analog inputs IN1 and IN2, a first AC voltage-to-current_loop converter 48, and a second AC voltage-to-current loop converter 50. The programmable logic controller is well known to those in the art and generally possesses programming functionality, as well as a variety of inputs and outputs. In a constructed embodiment, a PLC is already available in the manufacturing line, and is therefore utilized so as to avoid redundant computing equipment. It should be understood, however, that a PLC is not required; that other means or equipment for performing the described functions (e.g., general purpose computer) may be substituted, and remain within the spirit and scope of the invention. Voltage-to-current loop converters 48 and 50 convert sensed AC voltages into a proportional valued current ranging between 0-20 milliamps (mA), also as known, and standard, in the art. Converters 48 and 50 may comprise conventional components, such as a Phoenix Contact MCR-VAC-UI-0-DC, a model that converts AC voltage to an analog output, available from Phoenix Contact, Inc., USA, Middletown, Pa. USA. Other components could be used, for example, an AC meter card for a PLC.

FIG. 3 shows a method of determining an inductance of an ignition coil for use in manufacture thereof (i.e., adjusting air gap) according to the invention. The controller 44 is configured to operate in one of two modes: a calibration mode, and a test mode. The method begins in step 52 in the calibration mode.

In step 52, a calibration mode is entered into wherein a master coil 42 having a predetermined, known inductance, is placed into the test circuit 34 via the structure 40. A series circuit comprising AC source 36, resistor 38, and master coil 42 results. The impedance of coil 42 is calculated and entered into PLC 46 (or PLC calculates it based on an input, known inductance), based on the known inductance, hereinafter designated X_{L(MASTERCOIL)}. The method proceeds to step 54.

In step 54 (after AC source 36 is activated), circuit 34 measures the voltage, herein designated V₁, across master coil 42, and determines the root mean square (RMS) current, hereinafter designated I₁, in accordance with the following equation:

$${I}_{1} = \frac{{V}_{1}}{{X}_{L ( MASTERCOIL )}} \qquad ( 1 )$$

where X_{L} equals 2*π*f (of AC source)*L (of Master Coil-Known). In one embodiment, f=60 Hz and L=8 mH

In step 56, while still in the calibration mode, PLC 46 measures the voltage across resistor 38 (hereinafter designated V₂) and to thereafter determine an “actual resistance” of the test circuit 34, hereinafter designated R_{(ACTUAL)}, according to the following equation:

$${R}_{( ACTUAL )} = \frac{{V}_{2}}{{I}_{1}} \qquad ( 2 )$$

The foregoing calibration steps 52-56 are performed once initially, and thereafter steps 58-66 (i.e., the test mode) are repeated for each ignition coil 10 being assembled.

In step 58, master coil 42 is replaced with ignition coil 10. A winding thereof (e.g., one of the primary winding or the secondary winding, preferably the primary winding) is coupled to circuit 34 via structure 40. The method proceeds to step 60.

In step 60, PLC 46, in the test mode, measures the voltages across the resistive element 38, hereinafter designated V₃, and the ignition coil 10 under test, hereinafter designated V₄. The method proceeds to step 62.

In step 62, PLC 46 determines the current through the test circuit 34 when the ignition coil 10 is inserted therethrough, such current being designated I₂ hereinafter, according to the following equation:

$${I}_{2} = \frac{{V}_{3}}{{R}_{( ACTUAL )}} \qquad ( 3 )$$

In step 64, the impedance of the ignition coil, designated X_{L}(IGNITION COIL), is determined by PLC 46 in accordance with the following equation:

$${X}_{L} ( IGNITIONCOIL ) = \frac{{V}_{4}}{{I}_{2}} \qquad ( 4 )$$

However, since the impedance X_{L}(IGNITION COIL) is also equal to (2)*(π)*(f)*L(IGNITION COIL), the actual inductance of the ignition coil may be determined as follows:

$${L}_{( IGNITIONCOIL )} = \frac{{V}_{4}}{( 2 ) * ( π ) * ( f ) * ( {I}_{2} )} = \frac{( {V}_{4} ) * ( {R}_{( ACTUAL )} )}{( 2 ) * ( π ) * ( f ) * ( {V}_{3} )} \qquad ( 5 )$$

where f is equal to the frequency of the output signal of source 36, namely, 60 Hz in the described embodiment

The steps 60, 62 and 64 are continuously repeated by PLC 46 while step 66, the adjustment of the air gap 28, is preferably made by a programmed machine until the actual inductance of coil 10 is equal to a desired inductance. Of course, such adjustment may also be made manually by an operator or in other ways known in the art. Then, the first core member 12 and second core member 14 are secured, such as by welding.

The system and method according to the present invention provides a reduced cost, real-time inductance measurement and read out capability, which will enable an increased precision in the adjustment of ignition coils, particularly the air gap thereof. In addition, the present method and system provides superior immunity to noise presented by the operation of co-located welding machines, such as TIG welders.

1. A method of making an ignition coil comprising the steps of:
(A) calibrating a test circuit using a predetermined inductance to thereby determine a resistance value of the circuit;
(B) determining an inductance value associated with the ignition coil using the determined resistance value;
(C) adjusting an air gap in a core portion of the coil so that the inductance value equals a desired inductance value.

2. The method of claim 1 wherein said core portion comprises a W-shaped part and an I-shaped part and the air gap is defined between a center leg of the W-shaped part and the I-shaped part, the method further comprising the step of securing the W-shaped part and the I-shaped part together having the adjusted air gap.

3. The method of claim 2 wherein said securing step is performed by the substep of:
welding the W-shaped part and the I-shaped part together.

4. The method of claim 1 wherein the test circuit includes an alternating current (AC) power source connected in series with a resistive element, and said predetermined inductance comprises a master coil having a known inductance, said calibrating step comprising the substep of inserting the master coil in series with the AC power source and the resistive element.

5. The method of claim 4 wherein said calibrating step further includes the substeps of:
measuring a first voltage developed across the master coil;
calculating a first impedance of the master coil using the predetermined inductance value;
determining a first current level in the test circuit using the first voltage and the calculated first impedance;
measuring a second voltage developed across the resistive element; and
determining the resistance value of the circuit using the first current level and the second voltage.

6. The method of claim 5 further including the step of replacing the master coil with the ignition coil.

7. The method of claim 6 wherein said step of determining the inductance value includes the substeps of:
determining a third voltage across the resistive element;
calculating a second current level using the third voltage and the determined resistance value;
determining a fourth voltage across the ignition coil;
calculating a second impedance using the fourth voltage and the second current level; and
determining the inductance of the ignition coil using the second impedance.

8. The method of claim 7 wherein the substep of determining the ignition coil inductance is performed according to the relationship:
$$L = \frac{{X}_{L}}{( 2 ) ( π ) ( f )}$$
where L=the inductance of the ignition coil;
X_{L} is the second impedance corresponding to the fourth voltage divided by the second current level;
f=the frequency of the AC power source.

9. An apparatus comprising:
an alternating current (AC) power source having first and second output terminals;
a resistive element having first and second ends and connected in series with said AC power source, said first end being connected to said first terminal;
structure at said second output terminal and said second end of said resistive element configured to receive one of a master coil having a known inductance and an ignition coil; and
a controller configured, when said master coil is received in said structure in a calibration mode, to determine a first voltage across said master coil and a second voltage across said resistive element, said controller being further configured to determine a resistance value of said resistive element using said first and second voltages and said known inductance;
said controller being further configured, when said ignition coil is received in said structure in a test mode, to determine a third voltage across said resistive element and a fourth voltage across said ignition coil, said controller being further configured to determine an inductance value of said ignition coil using said third and fourth voltages and said determined resistance value.

10. The apparatus of claim 9 wherein said controller comprises a programmable logic controller (PLC), said apparatus further including a first voltage-to-current-loop converter coupled between said resistive element and said PLC, and a second voltage-to-current-loop converter coupled between said structure and said PLC.

11. The apparatus of claim 9 wherein said AC power source comprises a transformer.
